(19) United States
(12) Patent Application Publication
(10) Pub. No.: US 2026/0245381 A1
(43) Pub. Date: Aug. 20, 2026

(54) FOOD MANAGEMENT DEVICE, FOOD MANAGEMENT SYSTEM, FOOD MANAGEMENT METHOD, FOOD MANAGEMENT PROGRAM, AND STORAGE MEDIUM

(71) Applicant: Sharp Display Technology Corporation, Kameyama City (JP)

(72) Inventor: Hiroyuki KITO, Kameyama City (JP)

(21) Appl. No.: 19/451,298

(22) Filed: Jan. 16, 2026

(30) Foreign Application Priority Data
Feb. 20, 2025 (JP) 2025-026189

(51) Int. Cl. G06V 20/68; F25D 29/00; G06Q 10/087; G06T 7/70; G06V 10/764

(52) U.S. Cl. CPC G06V 20/68; F25D 29/00; G06Q 10/08774; G06Q 10/08776; G06T 7/70; G06V 10/764; F25D 2500/06; F25D 2700/06; G06T 2207/20081; G06T 2207/30128; G06T 2207/30242

(57) ABSTRACT

A food management device (MA) in accordance with the present disclosure includes: a location identifying section (14) that identifies a location of a food item which is shown in a first image showing an inside of a storage compartment: an identifier assignment section (21) that assigns an identifier to each food item; a type determination section (15) that determines, for each food item, a type of a food item; and a storage section (30) that stores, as stock information, each food item in association with the identifier, the location, and the type.

### DESCRIPTION

This Nonprovisional application claims priority under 35 U.S.C. §119 on Patent Application No. 2025-026189 filed in Japan on February 20, 2025, the entire contents of which are hereby incorporated by reference.

### TECHNICAL FIELD

The present disclosure relates to a food management device, a food management system, a food management method, a food management program, and a storage medium.

### BACKGROUND ART

A food management system disclosed in Patent Literature 1 includes: a refrigeration compartment camera that captures an image of an opening of a refrigeration compartment of a refrigerator; a drawer camera that captures an image of a drawer having been drawn out from a storage compartment which is not the refrigeration compartment; and a food detection section that detects, on the basis of the results of the image-capturing carried out by the refrigeration compartment camera and the drawer camera, a food item which is put into or put out from the refrigerator.

### Citation List

### Patent Literature

### Patent Literature 1

Japanese Patent Application Publication, Tokukai, No. 2022-162053

### SUMMARY

A food management device in accordance with an aspect of the present disclosure includes: a location identifying section that analyzes a first image showing an inside of a storage compartment of a refrigerator so as to identify a location, in the storage compartment, of at least one food item shown in the first image; an identifier assignment section that assigns an identifier to each of the at least one food item; a type determination section that analyzes, for each of the at least one food item, a second image which shows the inside of the storage compartment and the each of the at least one food item, so as to determine a type of the each of the at least one food item; and a storage section that stores, as stock information, each of the at least one food item in association with the identifier, the location, and the type.

A food management system in accordance with an aspect of the present disclosure includes: a food management device in accordance with an aspect of the present disclosure; and the refrigerator.

A food management method in accordance with an aspect of the present disclosure includes: a location identifying step of analyzing a first image showing an inside of a storage compartment of a refrigerator so as to identify a location, in the storage compartment, of at least one food item shown in the first image; an identifier assignment step of assigning an identifier to each of the at least one food item; a type determination step of analyzing, for each of the at least one food item, a second image which shows the inside of the storage compartment and the each of the at least one food item, so as to determine a type of the each of the at least one food item; and a storage step of storing, as stock information, each of the at least one food item in association with the identifier, the location, and the type.

A food management program in accordance with an aspect of the present disclosure is a food management program causing a computer to function as a food management device in accordance with an aspect of the present disclosure, the food management program causing the computer to function as the location identifying section, the identifier assignment section, the type determination section, and the storage section.

A storage medium in accordance with the present disclosure is a computer-readable, non-transitory storage medium storing therein a food management program in accordance with the present disclosure.

### BRIEF DESCRIPTION OF DRAWINGS

FIG. 1 is a view schematically illustrating an example of a configuration of a refrigerator including a food management device in accordance with an embodiment of the present disclosure.

FIG. 2 is a functional block diagram illustrating an example of a configuration of the food management device shown in FIG. 1.

FIG. 3 is a flowchart illustrating an example of a food management method executed by the food management device shown in FIG. 2.

FIG. 4 is a flowchart illustrating an example of an expiration date setting method executed by an expiration date setting section of the food management device shown in FIG. 2.

FIG. 5 is a flowchart illustrating an example of a food management method executed by the food management device shown in FIG. 2.

FIG. 6 is a view schematically illustrating an example of visual warning data in the food management method shown in FIG. 5.

FIG. 7 is a flowchart illustrating another example of the food management method executed by the food management device shown in FIG. 2.

FIG. 8 is a flowchart illustrating an example of the food management method executed by the food management device shown in FIG. 2.

FIG. 9 is a view schematically illustrating an example of a screen displayed on a user interface in the food management method shown in FIG. 8.

FIG. 10 is a view schematically illustrating an example of first data indicative of a location in the food management method shown in FIG. 8.

FIG. 11 is a flowchart illustrating another example of the food management method executed by the food management device shown in FIG. 2.

FIG. 12 is a view schematically illustrating an example of first data indicative of a location and second data indicative of an expiration date and a remaining quantity in the food management method shown in FIG. 11.

FIG. 13 is a view schematically illustrating an example of a configuration of a food management system including a food management device in accordance with an embodiment of the present disclosure.

### DESCRIPTION OF EMBODIMENTS

The configuration disclosed in Patent Literature 1 merely detects ingress and egress of food. Thus, in a case where a plurality of the same type of food items are housed in a refrigerator, it is difficult to individually manage the plurality of the same type of food items.

In order to enhance the accuracy in food management, it is requested to individually manage each of the food items in the refrigerator. An aspect of the present disclosure has an object to individually manage a plurality of the same type of food items in a refrigerator.

### First Embodiment

### Configuration of refrigerator

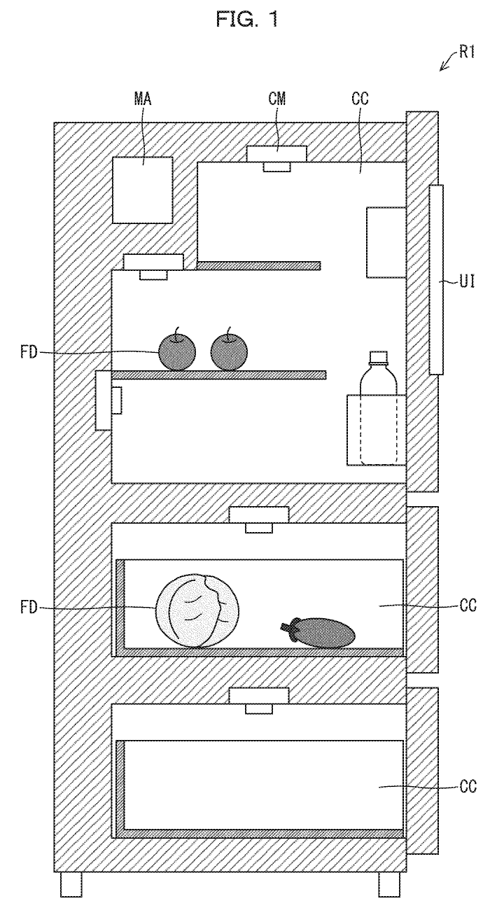

FIG. 1 is a view schematically illustrating an example of a configuration of a refrigerator including a food management device in accordance with an embodiment of the present disclosure. As shown in FIG. 1, a refrigerator R1 includes: a storage compartment CC that can house a food item FD therein; a camera CM that captures an image showing an inside of the storage compartment CC; and a food management device MA in accordance with a first embodiment. The refrigerator R1 may include one or more storage compartments CC, and each storage compartment CC may be provided with one or more cameras CM. The refrigerator R1 may optionally include a storage compartment without a camera. For simple explanation, description will be made focusing on a single storage compartment CC and a camera CM for the single storage compartment CC. The following will not describe a case where the refrigerator R1 is empty or a case where the refrigerator R1 stores an object that is not food therein. Thus, in the following description, an object shown in an image captured by the camera CM is a food item FD.

### Configuration of food management device

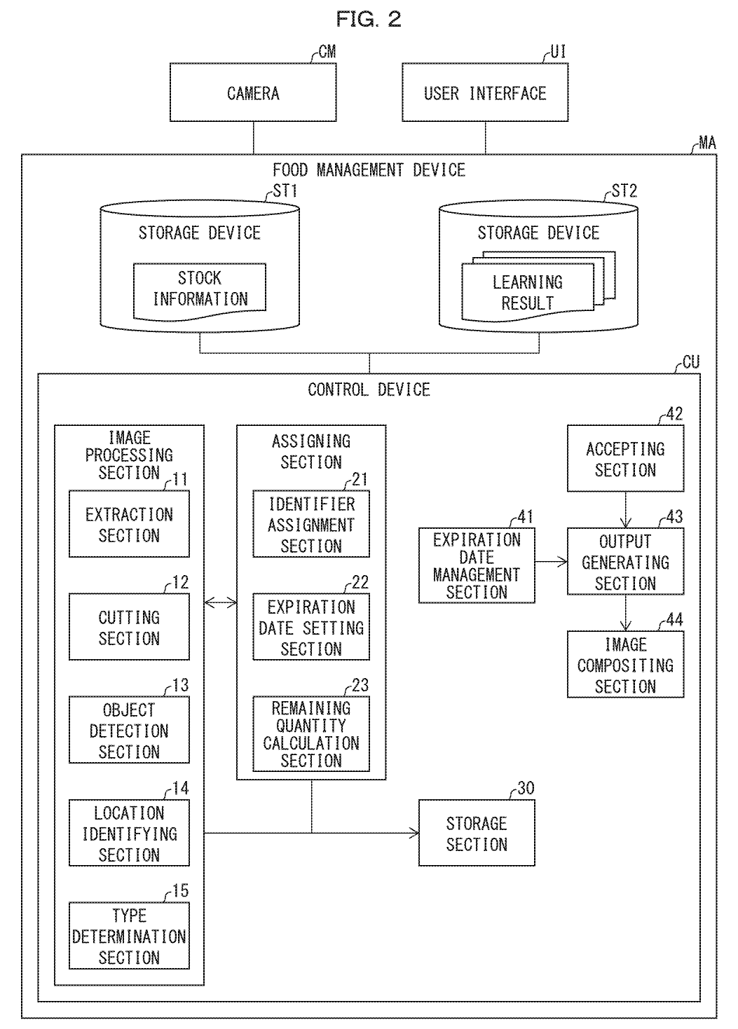

FIG. 2 is a functional block diagram illustrating an example of a configuration of the food management device shown in FIG. 1. As shown in FIG. 2, the food management device MA is connected with the camera CM, and includes a control device CU and one or more storage devices ST1 and ST2. The control device CU includes: (i) a location identifying section 14 that analyzes a first image showing an inside of the storage compartment CC of the refrigerator R1 so as to identify a location, in the storage compartment CC, of at least one food item FD shown in the first image; (ii) an identifier assignment section 21 that assigns an identifier to each of the at least one food item FD or a location of each of the at least one food item FD; (iii) a type determination section 15 that analyzes, for each of the at least one food item FD, a second image which shows the inside of the storage compartment CC and the each of at least one food item FD, so as to determine a type of the each of the at least one food item FD; and (iv) a storage section 30 that stores, as stock information, each of the at least one food item FD in association with the identifier, the location, and the type in the storage device ST1.

In accordance with the above configuration, each of the one or more food items FD is stored as stock information in association with the identifier, the location, and the type. Since the locations of the food items FD are individually stored, the pieces of data of the food items FD shown in the stock information can be respectively associated with actual food items FD. Therefore, even in a case where a plurality of the same type of food items FD are housed in the refrigerator R1, it is possible to individually manage the food items FD in the refrigerator R1.

The location identifying section 14 may identify a location of a food item FD on the basis of a learning result obtained through machine learning. The type determination section 15 may determine a type of the food item FD on the basis of the learning result obtained through machine learning. Each of these learning results may be stored in the storage device ST1 in which the stock information is also stored or the storage device ST2 in which the stock information is not stored.

The control device CU may further include an expiration date setting section 22 that sets, for each of at least one food item FD, an expiration date for the food item FD. The storage section 30 may store, in the storage device ST1, each of at least one food item FD in association with an identifier, a location, a type, and an expiration date as stock information. The expiration date of the food FD may be any of a best-before date, a use-by date, and other expiration dates. By the expiration date setting section 22, it is possible to reduce an effort required for a user to set the expiration date.

The expiration date setting section 22 sets an expiration date only for a food item FD whose location is not stored in the existing stock information at a current point of time, on the basis of the type of the food item FD and the current point of time. For the food item FD whose location is stored in the existing stock information, the expiration date setting section 22 sets an expiration date identical to the expiration date stored in the existing stock information. Consequently, it is possible to set a new expiration date for a new food item FD put into the refrigerator R1; meanwhile, it is possible to transfer a previously-set expiration date to a food item FD having been stocked in the refrigerator R1 previously. The expression "current point of time" herein refers to (i) a point of time that the expiration date setting section 22 sets the expiration date, (ii) a point of time that the camera CM captures the first image, or (iii) a given point of time during a period in which a series of processes from image-capturing of the first image to storing of stock information is carried out.

The control device CU may further include an expiration date management section 41 that manages an expiration date of at least one food item FD on the basis of the stock information. The expiration date management section 41 determines, for example, whether or not the at least one food item FD includes a food item FD having an expiration date which differs from the current point of time by a threshold or less. The expiration date management section 41 configured as above can find out a food item FD having an approaching expiration date. The expiration date management section 41 determines, for example, whether or not the at least one food item FD includes a food item FD having an expiration date which is earlier than a point of time that is after a threshold period from the current point of time. The expiration date management section 41 configured as above can find out a food item FD having an approaching expiration date or a food item FD having past its expiration date. The "current point of time" refers to a point of time that the expiration date management section 41 manages the expiration date. The expiration date management section 41 may manage the expiration date on the basis of a point of time designated in place of the current point of time, for example, on the basis of a date when user's vacation ends.

The control device CU may further include a remaining quantity calculation section 23 that calculates, for each type of food item FD, a remaining quantity of the at least one food item FD in the storage compartment CC. Consequently, it is possible to individually manage the food items FD and also to manage the food items FD by their types. For each type of food item FD, the storage section 30 may also store a remaining quantity of the food item FD as the stock information. In addition/alternatively, for each combination of the type of the food item FD and the expiration date, the remaining quantity may be calculated and stored. Alternatively, without storing the remaining quantity, the remaining quantity calculation section 23 may calculate the remaining quantity on the basis of the stock information as needed.

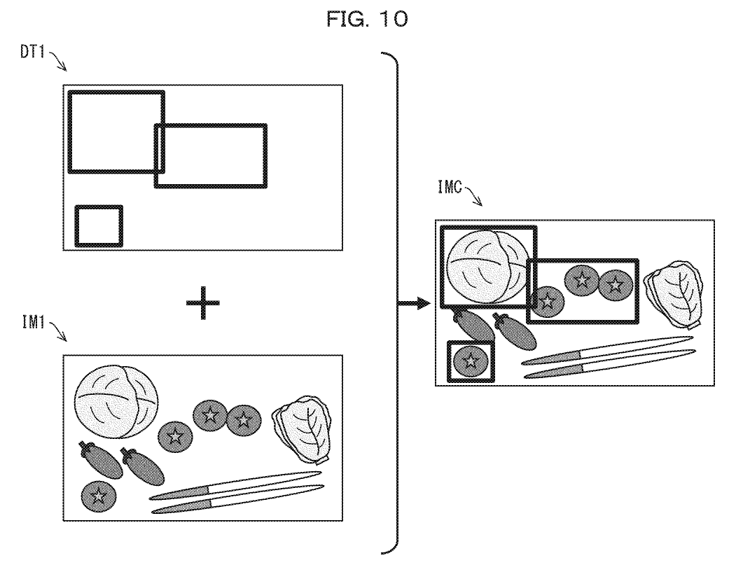

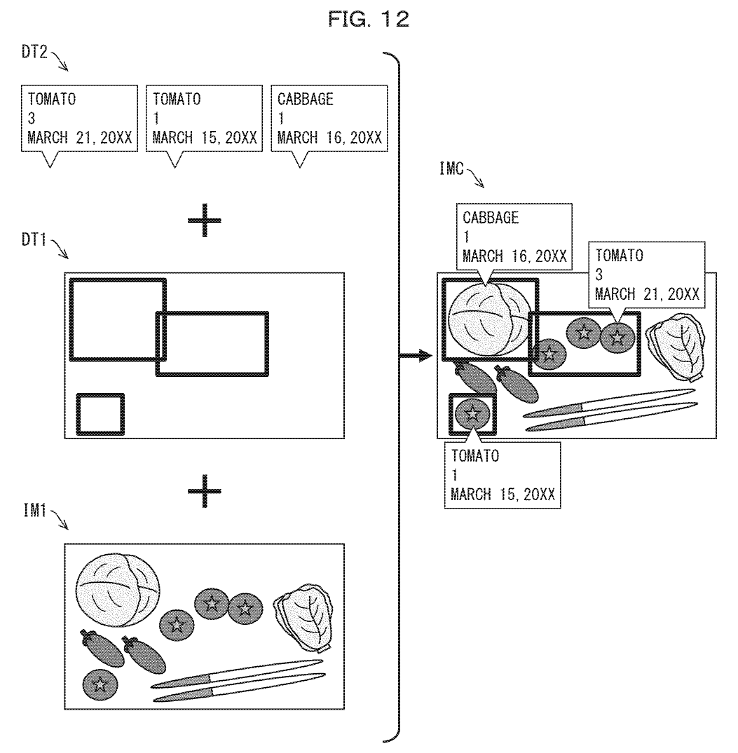

The control device CU may further include: (i) an accepting section 42 that accepts, on the basis of the stock information, designation information which designates at least one type from among the type of the at least one food item FD; and (ii) an output generating section 43 that generates, on the basis of the stock information, first data DT1 (see FIGS. 10 and 12) indicative of a location of a food item FD corresponding to the at least one type designated by the designation information. The refrigerator R1 may include a user interface UI, for example, a combination of a touch-panel display, a speaker, and a microphone or a combination of a physical button and a display. A user can input the designation information to the food management device MA via the user interface UI, and the food management device MA can provide the first data DT1 to the user via the user interface UI.

The control device CU may further include the remaining quantity calculation section 23 that calculates, for each combination of the type of the food item FD and the expiration date, a remaining quantity of the at least one food item FD in the storage compartment CC. Further, the output generating section 43 may generate, in addition to the first data, second data DT2 (see FIG. 12) indicative of an expiration date and a remaining quantity of a food item FD corresponding to at least one type designated by the designation information. The second data DT2 may also be provided to the user via the interface UI. A remaining quantity indicated by the second data DT2 is a remaining quantity calculated for each combination of the type of the food item FD and the expiration date.

The control device CU may include: (i) an extraction section 11 that extracts, as the first image, a valid frame from a moving image or a still image captured by the camera CM; (ii) a cutting section 12 that cuts out, as a second image, an area showing each food item FD from the first image; (iii) an object detection section 13 that detects an object from the first image; and (iv) an image compositing section 44 that composites the first data and the second data with the first image.

### Food management method

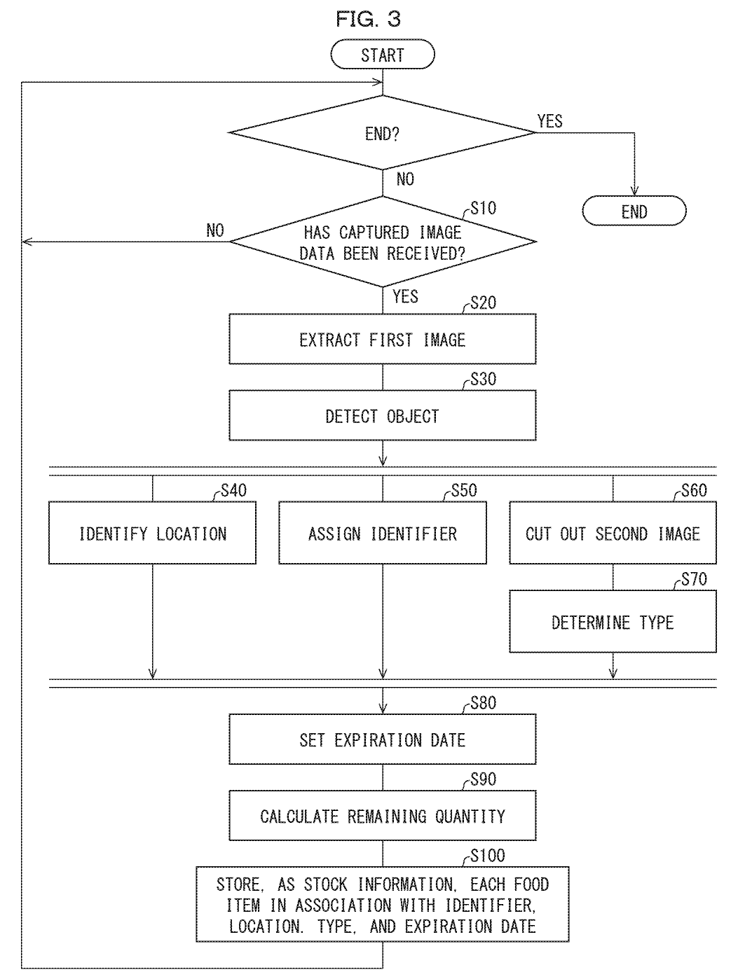

FIG. 3 is a flowchart illustrating an example of a food management method executed by the food management device shown in FIG. 2. The refrigerator R1 captures an image showing an inside of the storage compartment CC of the refrigerator R1 by the camera CM, and transmits the captured image data to the food management device MA. For example, the image-capturing may be carried out periodically. For another example, the image-capturing may be carried out at a time when an opening/closing sensor of the refrigerator R1 senses opening of the storage compartment CC or at a time when a user makes a request via the user interface UI. By the image-capturing, either a still image or a moving image may be obtained.

As shown in FIG. 3, the food management device MA determines whether or not the captured image data has been received (step S10). Upon reception of the captured image data, the extraction section 11 of the food management device MA extracts, as a first image, a valid frame from the captured image data (step S20), and the object detection section 13 of the food management device MA detects an object from the first image (step S30). The object thus detected is a food item FD. The extraction section 11 may extract the first image on the basis of a learning result obtained through machine learning. The object detection section 13 may detect the food item FD from the first image on the basis of the learning result obtained through machine learning. Each of these learning results may be stored in the storage device ST1 in which the stock information is also stored or the storage device ST2 in which the stock information is not stored.

Subsequently, the location identifying section 14 of the food management device MA analyzes the first image to identify a location, in the storage compartment CC, of at least one food item FD shown in the first image (step S40, location identifying step). Further, the identifier assignment section 21 of the food management device MA assigns an identifier to each of the at least one food item FD (step S50, identifier assignment step), and the type determination section 15 of the food management device MA analyzes a second image which shows the inside of the storage compartment CC and the food item FD, so as to determine a type of the food item FD (step S70, type determination step). The cutting section 12 of the food management device MA cuts out, as a second image, an area showing the first item FD from the first image (step S60), and the second image thus obtained may be used in step S70. The cutting section 12 may cut out the second image from the first image on the basis of a learning result obtained through machine learning. This learning result may be stored in the storage device ST1 in which the stock information is also stored or the storage device ST2 in which the stock information is not stored.

Then, the storage section 30 of the food management device MA stores, as stock information, each of the at least one food item FD in association with the identifier assigned in step S50, the location identified in step S40, and the type determined in step S70 (step S100, storage step). For all the food items FD detected in step S30, step S40, step S50, step S70, and step S100 are executed.

Optionally, the expiration date setting section 22 of the food management device MA may set an expiration date for each of the at least one food item FD (step S80, expiration date setting step). In this case, in step S100, the storage section 30 of the food management device MA may store, as stock information, each of the at least one food item FD in association with the identifier, the location, and the type as well as the expiration date set in step S80.

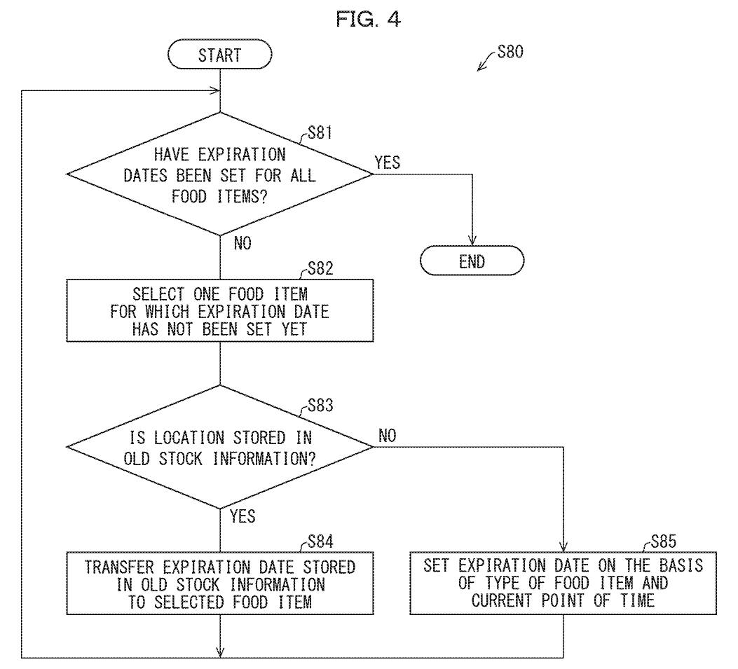

FIG. 4 is a flowchart illustrating an example of an expiration date setting method executed by the expiration date setting section of the food management device shown in FIG. 2. As shown in FIG. 4, the expiration date setting section 22 determines whether or not expiration dates have been set for all the food items FD detected in step S30 (step S81). Then, if any food item(s) FD for which an expiration date has not been set yet remain(s) (No in step S81), the expiration date setting section 22 selects one from among the food item(s) FD for which an expiration date has not been set yet (step S82). Then, the selected food item FD is compared with old stock information read from the storage device ST1, and it is determined whether or not the location of the selected food item FD is stored in the old stock information (step S83). If the location of the selected food item FD is stored in the old stock information (Yes in step S83), an expiration date is set for the selected food item FD such that the expiration date of the selected food item FD stored in the old stock information is transferred to the selected food item FD (step S84). If the location of the selected food item FD is not stored in the old stock information (No in step S83), an expiration date is set for the selected food item FD on the basis of the type of the selected food item FD and the current point of time (step S85). The expression "current point of time" herein refers to (i) a point of time that the expiration date setting section 22 sets an expiration date, (ii) a point of time that the camera CM captures a first image, or (iii) a given point of time during a period in which a series of processes from image-capturing of the first image to storing of stock information is carried out.

As shown in FIG. 3, the remaining quantity calculation section 23 of the food management device MA may optionally calculate, for each type of the food item FD, a remaining quantity of the at least one food item FD in the storage compartment CC (step S90, remaining quantity setting step). In this case, in step S100, as a part of the stock information, the storage section 30 of the food management device MA may store, for each type of the food item FD, the one or more food items FD in association with the remaining quantity of the one or more food items FD calculated in step S90. Alternatively, the remaining quantity calculation section 23 may calculate, for each combination of the type of the food item FD and the expiration date, a remaining quantity of the one or more food items FD, and the storage section 30 may store the remaining quantity thus calculated.

Optionally, in step S100, the storage section 30 of the food management device MA may store the first image as a part of the stock information.

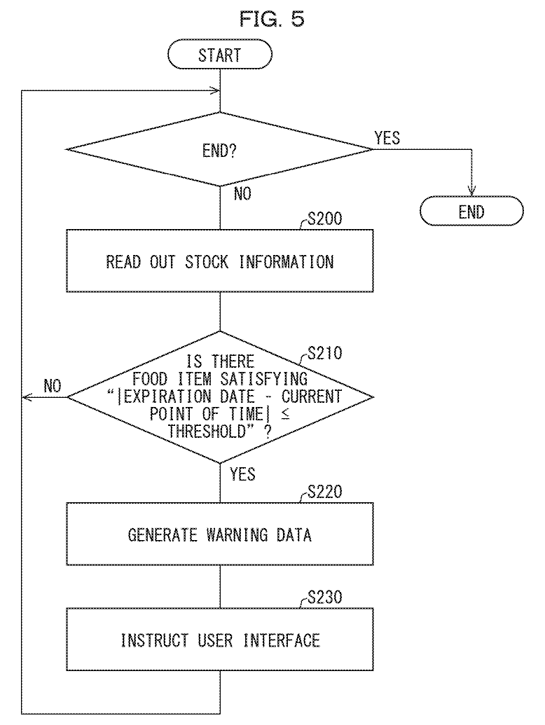

FIG. 5 is a flowchart illustrating an example of a food management method executed by the food management device shown in FIG. 2. As shown in FIG. 5, the expiration date management section 41 of the food management device MA reads out the stock information from the storage device ST1 (step S200), and determines, on the basis of the stock information, whether or not the at least one food item FD includes a food item FD having an approaching expiration date (step S210, first expiration date management step). To be more specific, a default threshold or a threshold designated by a user is used to determine whether or not there is a food item FD having an expiration date which differs from the current point of time by an absolute value difference being the threshold or less. This determination may be carried out periodically. Alternatively, this determination may be carried out at a time when an opening/closing sensor of the refrigerator R1 senses opening of the storage compartment CC or at a time when a user makes a request via the user interface UI.

The "current point of time" in step S210 refers to a point of time that the expiration date management section 41 executes step S210 or a given point of time during a period in which a series of processes including step S210 is carried out. For example, in a case where step S210 is executed when the opening/closing sensor of the refrigerator R1 senses opening of the storage compartment CC, the current point of time may be the point of time that the opening/closing sensor senses opening of the storage compartment CC.

The food management device MA may inform the user of a result of step S210 via the user interface UI, thereby supporting user's management of the expiration date of the food item FD. For example, in a case where there is a food item FD having an approaching expiration date, the food management device MA generates warning data (step S220), and instructs the user interface UI to execute this warning data (step S230).

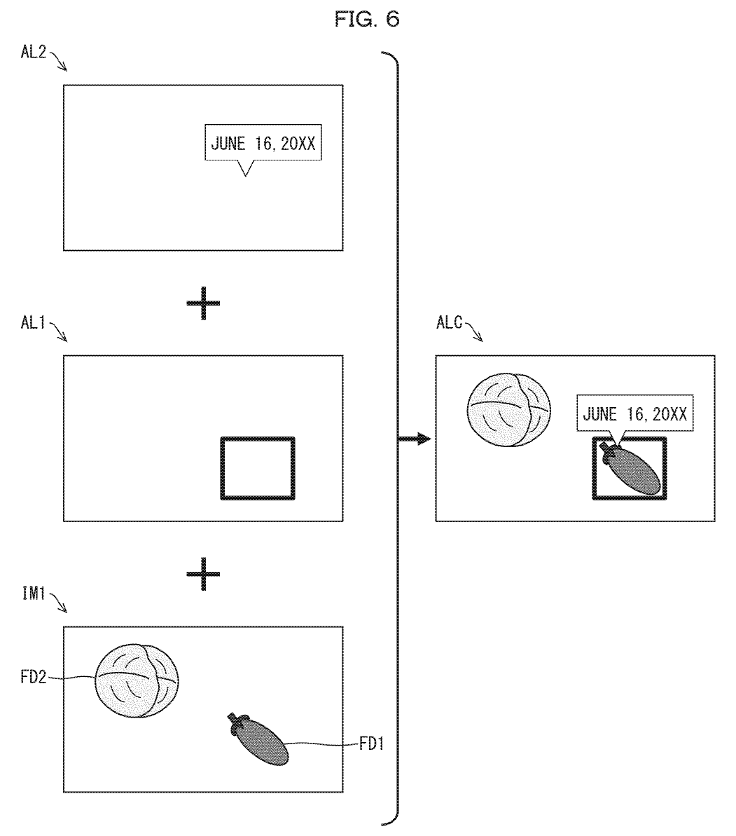

FIG. 6 is a view schematically illustrating an example of visual warning data in the food management method shown in FIG. 5. The example shown in FIG. 6 includes (i) an eggplant FD1 having an expiration date of June 16, 20XX as a food item FD having an approaching expiration date and (ii) a cabbage FD2 as a food item FD having a distant expiration date. In this case, the output generating section 43 of the food management device MA generates first warning data AL1 indicative of a location of the eggplant FD1 and second warning data AL2 indicative of an expiration date of the eggplant FD1. Then, the image compositing section 44 of the food management device MA reads out a first image IM1 from the storage device ST1, and composites the first warning data IM1 and the second warning data IM2 with the first image IM1 so as to generate composite warning data ALC. The food management device MA instructs the user interface UI to display the composite warning data ALC. In order to help the user associate the expiration date of the eggplant FD1 with the location of the eggplant FD1, it is preferable that the second warning data AL2 be generated and composited in accordance with the first warning data AL1.

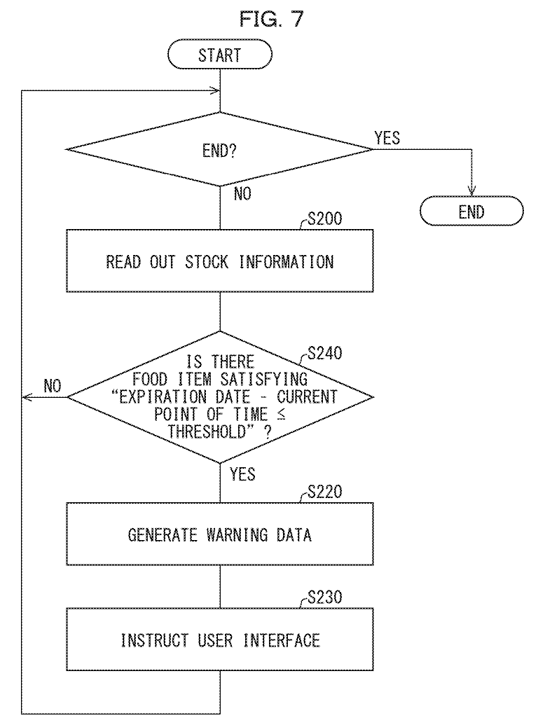

FIG. 7 is a flowchart illustrating another example of the food management method executed by the food management device shown in FIG. 2. As shown in FIG. 7, the expiration date management section 41 of the food management device MA determines, on the basis of the stock information, whether or not the at least one food item FD includes a food item FD having an approaching expiration date or a distant expiration date (step S240, second expiration date management step). Specifically, it is determined whether or not the at least one food item FD includes a food item FD having an expiration date which differs from a current point of time by a threshold or less. Here, an absolute value is not taken.

The "current point of time" in step S240 refers to a point of time that the expiration date management section 41 executes step S240 or a given point of time during a period in which a series of processes including step S240 is carried out. For example, in a case where step S240 is executed in response to user's request via the user interface UI, the current point of time may be a point of time that the user's request is input into the user interface UI.

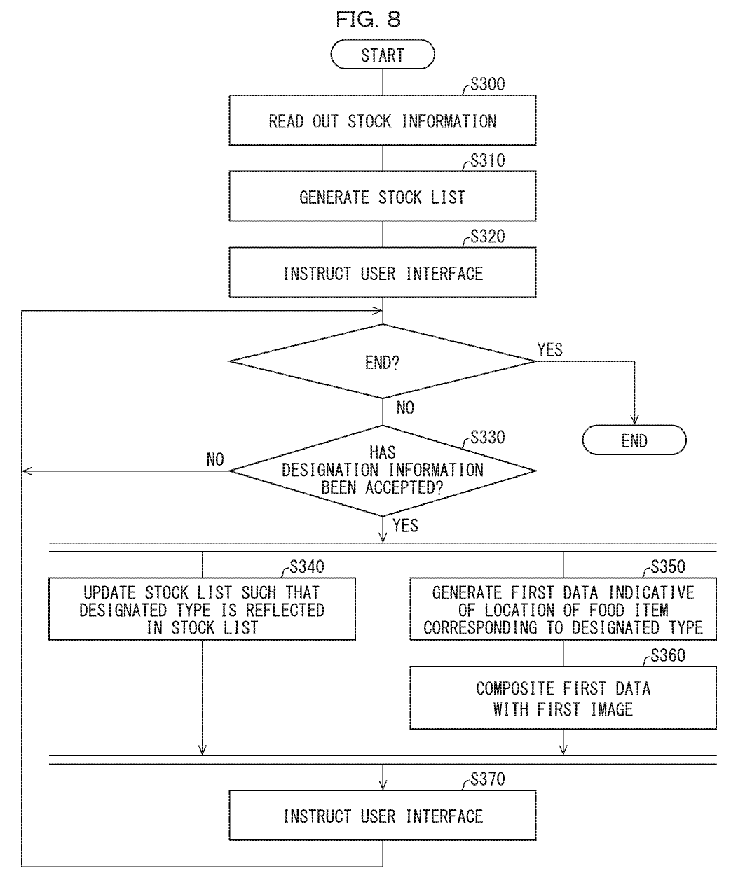

FIG. 8 is a flowchart illustrating an example of the food management method executed by the food management device shown in FIG. 2. As shown in FIG. 8, the accepting section 42 of the food management device MA reads out the stock information from the storage device ST1 (step S300), and accepts designation information which designates at least one type from among the type of the at least one food item FD on the basis of the stock information (step S330, accepting step).

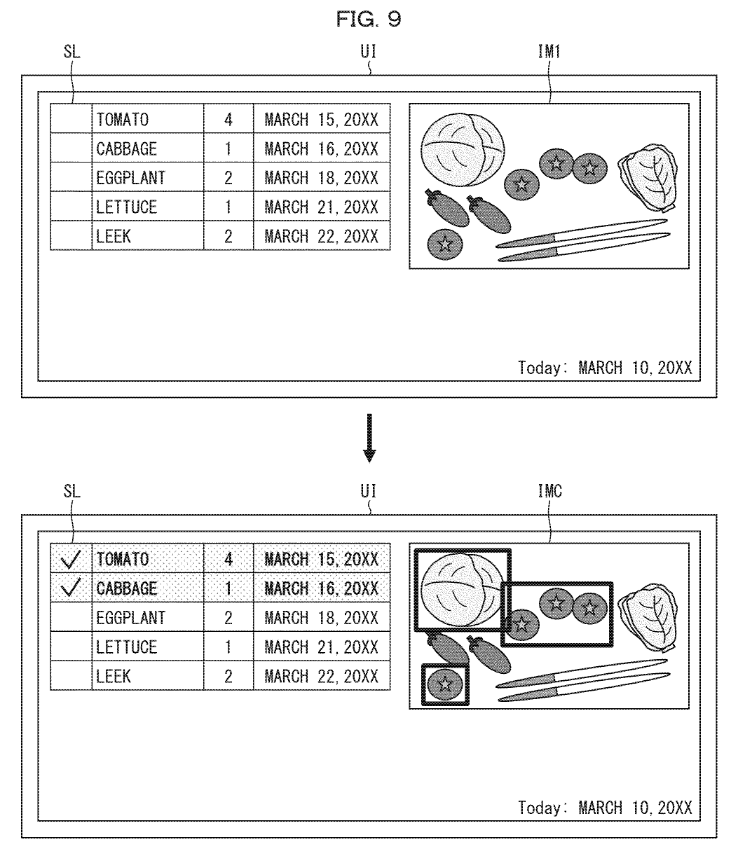

FIG. 9 is a view schematically illustrating an example of a screen displayed on the user interface in the food management method shown in FIG. 8. For example, in a case where the user interface UI includes a touch panel display, the output generating section 43 generates a stock list SL on the basis of the stock information (step S310), and the food management device MA instructs the user interface UI to display the stock list SL and the first image IM1 as illustrated in an upper part of FIG. 9 (step S320). The user designates at least one type from the stock list SL thus displayed, and the user interface UI transmits, to the food management device MA, designation information based on the designation. Then, in step S330, the accepting section 42 of the food management device MA determines whether or not the accepting section 42 has received the designation information from the user interface UI.

Preferably, the stock list SL is a user-friendly one. For example, in a case where there are food items FD which are of the same type but have different expiration dates, the stock list SL may include only one of the food items FD which has an earliest expiration date among the different expiration dates. For example, the stock list SL may be sorted in the order of expiration date or the order of remaining quantity.

FIG. 10 is a view schematically illustrating an example of first data indicative of a location in the food management method shown in FIG. 8. When the accepting section 42 receives the designation information, the output generating section 43 of the food management device MA updates the stock list SL such that the designation information is reflected in the stock list SL (step S340). For example, the updating is carried out by checking a checkbox corresponding to the designated type and/or changing a background color of a column corresponding to the designated type. Further, the output generating section 43 of the food management device MA generates first data DT1 indicative of a location of the food item FD corresponding to the type designated by the designation information, as shown in FIG. 10 (step S350). Then, the image compositing section 44 of the food management device MA composites the first data DT1 with the first image IM1 so as to generate a composite image IMC (step S360). The food management device MA instructs the user interface UI to display the stock list SL and the composite image IMC, as illustrated in a lower part of FIG. 9 (step S370).

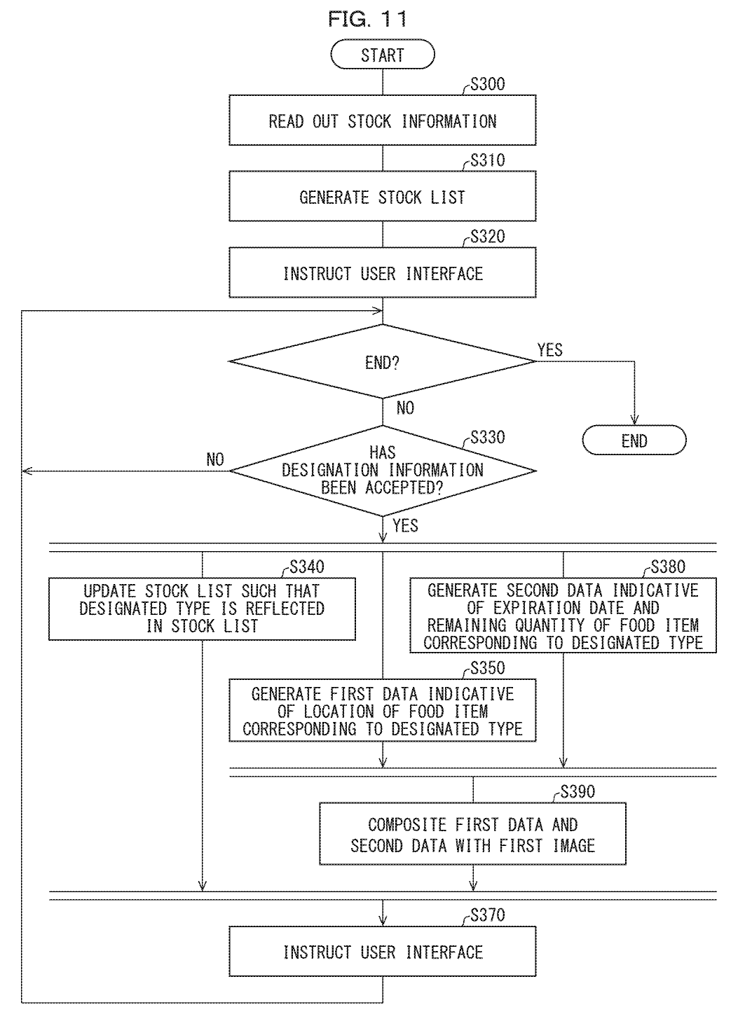

FIG. 11 is a flowchart illustrating another example of the food management method executed by the food management device shown in FIG. 2. FIG. 12 is a view schematically illustrating an example of first data indicative of a location and second data indicative of an expiration date and a remaining quantity in the food management method shown in FIG. 11. As shown in FIGS. 11 and 12, the output generating section 43 of the food management device MA may generate, in addition to the first data DT1, second data DT2 indicative of an expiration date and a remaining quantity of the food item FD corresponding to the type designated by the designation information (step S380). The remaining quantity is a remaining quantity calculated for each combination of the type of the food item FD and the expiration date. Then, the image compositing section 44 of the food management device MA composites the first data DT1 and the second data DT2 with the first image IM1 so as to generate a composite image IMC (step S390). In order to help the user associate the expiration date and the remaining quantity of the food item FD with the location of the food item FD, it is preferable that the second data DT2 be generated and composited in accordance with the first data DT1.

### Software Implementation

Functions of the food management device MA can be realized by a food management program for causing a computer to function as the food management device MA, the food management program causing the computer to function as the location identifying section 14, the identifier assignment section 21, the type determination section 15, and the storage section 30. The food management program may optionally cause the computer to function as each of the other control blocks of the food management device MA (each of the sections included in the control device CU).

In this case, the food management device MA includes, as hardware for executing the above program, a computer that includes at least one control device (e.g., a processor) and at least one storage device (e.g., a memory). By executing the above program with the control device and the storage device, the functions described in the above embodiment are realized. The storage device for executing the program may or may not be the same as the storage device ST1 configured to store stock information therein, or may or may not be the same as the storage device ST2 having a learning result stored therein.

The food management program described above can be stored in at least one computer-readable, non-transitory storage medium. The storage medium can be provided in the food management device MA, or the storage medium does not need to be provided in the food management device MA. In the latter case, the above program can be supplied to the food management device MA via an arbitrary wired or wireless transmission medium.

Further, one or some or all of respective functions of the control blocks described above can be realized by a logic circuit. For example, an integrated circuit in which a logic circuit that functions as each of the control blocks is formed is also encompassed in the scope of the present disclosure. In addition, the respective functions of the control blocks described above can be realized by, for example, a quantum computer.

The respective processes in the control blocks of the food management device MA may be carried out by artificial intelligence (AI). In this case, AI may be operated in the control device, or may be operated in another device (e.g., an edge computer or a cloud server).

### Second Embodiment

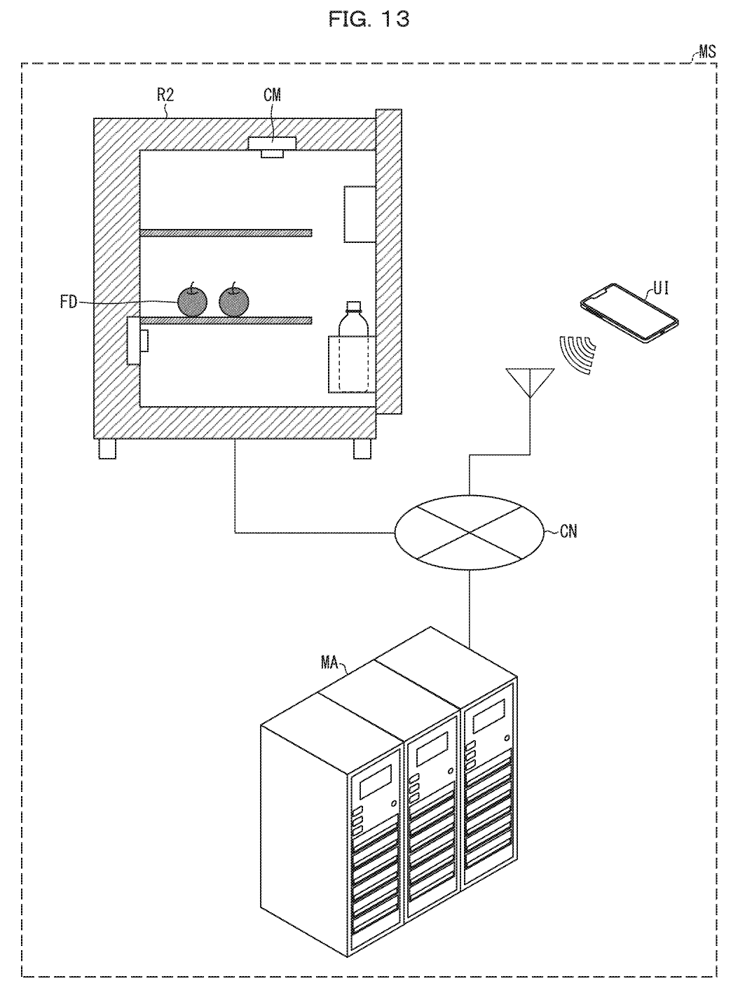

FIG. 13 is a view schematically illustrating an example of a configuration of a food management system including a food management device in accordance with an embodiment of the present disclosure. As shown in FIG. 13, a food management system MS includes one or more refrigerator R2 and a food management device MA in accordance with the present disclosure. Each refrigerator R2 includes: a storage compartment CC in which a food item FD is housed; and a camera CM which captures an image showing an inside of the storage compartment CC.

The food management device MA in accordance with the present disclosure may be realized by devices other than the refrigerator(s) R2, and may be connected with the camera CM or a control section which controls the camera CM. Some of the food management device MA in accordance with the present disclosure may each be realized by a corresponding one of the refrigerators R2, and the other part(s) of the food management device MA may be realized by devices other than the refrigerator(s) R2. The food management device MA may be realized by a plurality of devices that are mutually connected with each other, and one or more of the plurality of devices is/are connected with the camera CM or the control section which controls the camera CM. For example, as the food management device MA, (i) a computer connected with the refrigerator(s) R2 via a local area network (LAN) or (ii) a combination of a remote server connected with the refrigerator(s) R2 via the Internet and an external storage device attached to the remote server may be used.

The food management device MA may be connected with one or more user interfaces UI. Each user interface UI may be provided to the refrigerator(s) R2 or to a device which is not the refrigerator(s) R2. The user interface UI may be, for example, an information terminal such as a smartphone, a tablet computer, a smart speaker, or a laptop computer.

In the example shown in FIG. 13, the food management system MS includes: the food management device MA constituted by one refrigerator R2 and one remote server; and the user interface UI realized by one information terminal. The refrigerator R2 and the user interface UI are connected with the food management device MA via a communication network CN.

Examples of a relation between the server and the information terminal include a pull-based model and a push-based model. According to the pull-based communication, the server transmits information to the information terminal in response to a request from the information terminal. According to the push-based communication, the server transmits information to the information terminal spontaneously. A relation between the food management device MA and the user interface UI in the food management system MS may be either the pull-based model or the push-based model or both the pull-based model and the push-based model.

### Aspects of the disclosure can also be expressed as follows:

A food management device (MA) in accordance with a first aspect of the present disclosure includes: a location identifying section (14) that analyzes a first image showing an inside of a storage compartment (CC) of a refrigerator (R1, R2) so as to identify a location, in the storage compartment (CC), of at least one food item (FD) shown in the first image; an identifier assignment section (21) that assigns an identifier to each of the at least one food item; a type determination section (15) that analyzes, for each of the at least one food item, a second image which shows the inside of the storage compartment and the each of the at least one food item, so as to determine a type of the each of the at least one food item; and a storage section (30) that stores, as stock information, each of the at least one food item in association with the identifier, the location, and the type.

A food management device in accordance with a second aspect of the present disclosure may be configured such that, in the first aspect of the present disclosure, the food management device further includes: an expiration date setting section (22) that sets an expiration date for each of the at least one food item, wherein the storage section stores, as the stock information, each of the at least one food item in association with the identifier, the location, the type, and the expiration date.

A food management device in accordance with a third aspect of the present disclosure may be configured such that, in the second aspect of the present disclosure, the expiration date setting section sets the expiration date only for a food item whose location is not registered in the stock information at a current point of time, on a basis of a type of the food item and the current point of time.

A food management device in accordance with a fourth aspect of the present disclosure may be configured such that, in the second or third aspect of the present disclosure, the food management device further includes: an expiration date management section (41) that determines, on a basis of the stock information, whether or not the at least one food item includes a food item having the expiration date which differs from a current point of time by a threshold or less.

A food management device in accordance with a fifth aspect of the present disclosure may be configured such that, in the second or third aspect of the present disclosure, the food management device further includes: an expiration date management section (41) that determines, on a basis of the stock information, whether or not the at least one food item includes a food item having an expiration date which is earlier than a point of time that is after a threshold period from the current point of time.

A food management device in accordance with a sixth aspect of the present disclosure may be configured such that, in any one of the first to fifth aspects of the present disclosure, the food management device further includes: a remaining quantity calculation section (23) that calculates, for each of the types of the at least one food item, a remaining quantity of the at least one food item in the storage compartment.

A food management device in accordance with a seventh aspect of the present disclosure may be configured such that, in any one of the first to sixth aspects of the present disclosure, the food management device further includes: an accepting section (42) that accepts, on a basis of the stock information, designation information which designates at least one type from among the type of at least one food item; and an output generating section (43) that generates, on a basis of the stock information, first data (DT1) indicative of a location of a food item corresponding to the at least one type designated by the designation information.

A food management device in accordance with an eighth aspect of the present disclosure may be configured such that, in any one of the second to fifth aspects of the present disclosure, the food management device further includes: a remaining quantity calculation section (23) that calculates, for each combination of the type and the expiration date of the at least one food item, a remaining quantity of the at least one food item in the storage compartment; an accepting section (42) that accepts, on a basis of the stock information, designation information which designates at least one type of food item from among the at least one food item; and an output generating section (43) that generates first data (DT1) and second data (DT2) on the basis of the stock information, the first data being indicative of a location of a food item corresponding to the at least one type designated by the designation information, and the second data being indicative of an expiration date and a remaining quantity of the food item corresponding to the at least one type designated by the designation information.

A food management system (MS) in accordance with a ninth aspect of the present disclosure includes: a food management device (MA) in accordance with any one of the first to eighth aspects; and the refrigerator (R1, R2).

A food management method in accordance with a tenth aspect of the present disclosure includes: a location identifying step (step S40) of analyzing a first image showing an inside of a storage compartment of a refrigerator so as to identify a location, in the storage compartment, of at least one food item shown in the first image; an identifier assignment step (step S50) of assigning an identifier to each of the at least one food item; a type determination step (step S70) of analyzing, for each of the at least one food item, a second image which shows the inside of the storage compartment and the each of the at least one food item, so as to determine a type of the each of the at least one food item; and a storage step (step S100) of storing, as stock information, each of the at least one food item in association with the identifier, the location, and the type.

The food management device (MA) in accordance with each aspect of the present disclosure may be realized by a computer. In such a case, the present disclosure encompasses (i) a food management program for the food management device, the food management program causing a computer to function as the sections (software elements) included in the food management device and (ii) a computer-readable, non-transitory storage medium storing therein the food management program.

A food management program in accordance with an eleventh aspect of the present disclosure is a food management program for causing a computer to function as a food management device (MA) recited in any one of the first to eighth aspects, the food management program causing the computer to function as the location identifying section (14), the identifier assignment section (21), the type determination section (15), and the storage section (30).

A storage medium in accordance with a twelfth aspect of the present disclosure is a computer-readable, non-transitory storage medium having a food management program recite in the eleventh aspect stored therein.

The present disclosure is not limited to the above-described embodiments, but can be altered by a skilled person in the art within the scope of the claims. The present disclosure also encompasses, in its technical scope of the present disclosure, any embodiment derived by combining technical means disclosed in differing embodiments. Further, a novel technical feature can be created by a combination of technical means disclosed in these embodiments.

### REFERENCE SIGNS LIST

14: location identifying section

15: type determination section

21: identifier assignment section

22: expiration date setting section

23: remaining quantity calculation section

41: expiration date management section

42: accepting section

43: output generating section

CC: storage compartment

CM: camera

DT1: first data

DT2: second data

FD: food item

IM1: first image

MA: food management device

MS: food management system

R1, R2: refrigerator

1. A food management device comprising:
a location identifying section that analyzes a first image showing an inside of a storage compartment of a refrigerator so as to identify a location, in the storage compartment, of at least one food item shown in the first image;
an identifier assignment section that assigns an identifier to each of the at least one food item;
a type determination section that analyzes, for each of the at least one food item, a second image which shows the inside of the storage compartment and the each of the at least one food item, so as to determine a type of the each of the at least one food item; and
a storage section that stores, as stock information, each of the at least one food item in association with the identifier, the location, and the type.

2. The food management device according to claim 1, further comprising:
an expiration date setting section that sets an expiration date for each of the at least one food item, wherein
the storage section stores, as the stock information, each of the at least one food item in association with the identifier, the location, the type, and the expiration date.

3. The food management device according to claim 2, wherein:
the expiration date setting section sets the expiration date only for a food item whose location is not registered in the stock information at a current point of time, on a basis of a type of the food item and the current point of time.

4. The food management device according to claim 2, further comprising:
an expiration date management section that determines, on a basis of the stock information, whether or not the at least one food item includes a food item having an expiration date which differs from a current point of time by a threshold or less.

5. The food management device according to claim 2, further comprising:
an expiration date management section that determines, on a basis of the stock information, whether or not the at least one food item includes a food item having the expiration date which is earlier than a point of time that is after a threshold period from the current point of time.

6. The food management device according to claim 1, further comprising:
a remaining quantity calculation section that calculates, for each of the types of the at least one food item, a remaining quantity of the at least one food item in the storage compartment.

7. The food management device according to claim 1, further comprising:
an accepting section that accepts, on a basis of the stock information, designation information which designates at least one type from among the type of at least one food item; and
an output generating section that generates, on a basis of the stock information, first data indicative of a location of a food item corresponding to the at least one type designated by the designation information.

8. The food management device according to claim 2, further comprising:
a remaining quantity calculation section that calculates, for each combination of the type and the expiration date of the at least one food item, a remaining quantity of the at least one food item in the storage compartment;
an accepting section that accepts, on a basis of the stock information, designation information which designates at least one type of food item from among the at least one food item; and
an output generating section that generates first data and second data on the basis of the stock information, the first data being indicative of a location of a food item corresponding to the at least one type designated by the designation information, and the second data being indicative of an expiration date and a remaining quantity of the food item corresponding to the at least one type designated by the designation information.

9. A food management system comprising:
a food management device recited in claim 1; and
the refrigerator.

10. A food management method comprising:
a location identifying step of analyzing a first image showing an inside of a storage compartment of a refrigerator so as to identify a location, in the storage compartment, of at least one food item shown in the first image;
an identifier assignment step of assigning an identifier to each of the at least one food item;
a type determination step of analyzing, for each of the at least one food item, a second image which shows the inside of the storage compartment and the each of the at least one food item, so as to determine a type of the each of the at least one food item; and
a storage step of storing, as stock information, each of the at least one food item in association with the identifier, the location, and the type.

11. A computer-readable, non-transitory storage medium having a food management program stored therein, the food management program causing a computer to function as a food management device recited in claim 1, the food management program causing the computer to function as the location identifying section, the identifier assignment section, the type determination section, and the storage section.
